(19) United States
(12) Patent Application Publication
(10) Pub. No.: US 2010/0241484 A1
(43) Pub. Date: Sep. 23, 2010

(54) System and Method to Provide Consumables

(75) Inventor: Mark Edward Nichols, Christchurch (NZ)

Correspondence Address: CROWELL & MORING LLP;INTELLECTUAL PROPERTY GROUP, P.O. BOX 14300, WASHINGTON, DC, 20044-4300, US

(73) Assignee: Trimble Navigation Limited, Sunnyvale, CA (US)

(21) Appl. No.: 12/408,272

(22) Filed: Mar. 20, 2009

(51) Int. Cl. G06Q 10/00; G01C 21/00; G06Q 30/00

(52) U.S. Cl. 705/9; 701/213; 705/80; 705/28

(57) ABSTRACT

System and method for providing consumables to machines. In one embodiment, machine data indicating a remaining quantity of a machine consumable for a machine may be received by a server. A location may be received by the server providing a location of the machine. An estimated operational duration for the machine may be determined and a supplier may be selected to provide the machine consumable based, at least in part, on the estimated operational duration. The supplier may be requested to provide the machine consumable to the machine within a time period based on the estimated operational duration.

### FIELD OF THE INVENTION

The present invention relates in general to machines requiring consumables for operation and more particularly to a system and method for providing a consumable to a machine.

### BACKGROUND

For many owners and operators of machines requiring consumables, there is an ever present desire to minimize costs required to operate the machines. Similarly, there exists a desire for the machine to always be supplied with the necessary consumables to operate. Monitoring and replenishing consumables may be required for some machines to operate. Replenishing a supply of consumables for some machines may be relatively simple. However, providing consumables for many machines may be difficult due to the type of machine, particular consumable, or both.

Some device manufacturers have developed devices and methods of facilitating refilling of a consumable for a particular machine. For example, ink cartridges and containers for some printer devices have been designed for simple installation. However, many owners of these printing devices do not store extra cartridges for their machines. Thus, when an ink supply for a printing machine expires, users may experience a loss of productivity and/or expense due to depletion of the consumable. Further, a loss of time may be experienced due to an unexpected loss of ink. Many machines employing consumables may be subject to similar issues.

For owners and operators of machines which require a supplier to provide a consumable for the machine, similar issues may arise. For example, machines requiring fuel for operation may be halted when a fuel supply is depleted. Further, the location of the machine and/or type of machine may require delivery of fuel to the machine. Some conventional methods have attempted to provide fuel for machines, especially at remote sites. However, such systems have failed in large part due to their inability to provide sufficiently directed and machine-based fulfillment of a consumable resource to the device. Accordingly there is a need for a way to address fulfillment of at least one consumable for a machine.

### BRIEF SUMMARY OF THE INVENTION

Disclosed and claimed herein are a system and method for providing consumables to machines. In one embodiment, a process may include receiving machine data, by a server, indicating a remaining quantity of a machine consumable for a machine, receiving location data, by the server, providing a location of the machine determining an estimated operational duration for the machine, selecting a supplier to provide the machine consumable based, at least in part, on the estimated operational duration, and requesting that the supplier provide the machine consumable to the machine within a time period based on the estimated operational duration.

Other aspects, features, and techniques of the invention will be apparent to one skilled in the relevant art in view of the following detailed description of the invention.

### BRIEF DESCRIPTION OF THE DRAWINGS

FIGS. 1A-1B depict simplified system diagrams for a system to provide a consumable according to one or more embodiments of the invention;

FIGS. 2A-2B depict simplified block diagrams of machines, according to one or more embodiments of the invention;

FIG. 3 depicts a graphical representation of a work site according to one embodiment of the invention;

FIG. 4 depicts a process according to one embodiment of the invention;

FIG. 5 depicts a process according to one embodiment of the invention; and

FIG. 6 depicts process for selection of a supplier according to one embodiment of the invention.

### DETAILED DESCRIPTION OF EXEMPLARY EMBODIMENTS

One aspect of the present invention is directed to providing a consumable to a machine. In one embodiment, a process may be provided for delivery of a consumable based on one or more characteristics of the machine. For example, delivery of a consumable to the machine may be based on machine location, quantity of a consumable available to a machine, estimated operational duration of the machine, suppliers available to the machine, and the type of consumable. As used herein, a consumable may relate to a substance which a machine may use to operate. By way of example, a consumable may relate to one or more of fuel, oil, ink, paper, a mechanical part, and consumable substance in general. The process may include receiving machine data, establishing delivery of the consumable to the machine and negotiation of the delivery with one or more suppliers. According to another embodiment, the process may provide automated delivery of one or more consumables to a machine with or without user instructions. To that end, delivery of a consumable may be provided to machine in an efficient manner.

Another aspect of the invention relates to a system configured to provide one or more consumables for a machine. In one embodiment, the system may be configured for automated fulfillment of one or more consumables. According to another embodiment, the system may include a server in communication with a machine and at least one supplier to provide fulfillment of a service request to the machine. The system may further employ one or more communication means for fulfillment of the service request. In one exemplary embodiment, the system may be provided for delivery of fuel to a machine in a work site, such as an earthmoving project. However, it may also be appreciated that the system may be deployed to provide fulfillment of consumables to a wide variety of machines. For example, consumables may be delivered to one or more machines having one or more consumable elements. The system may further interoperate with a data communications network and/or a source of positioning data.

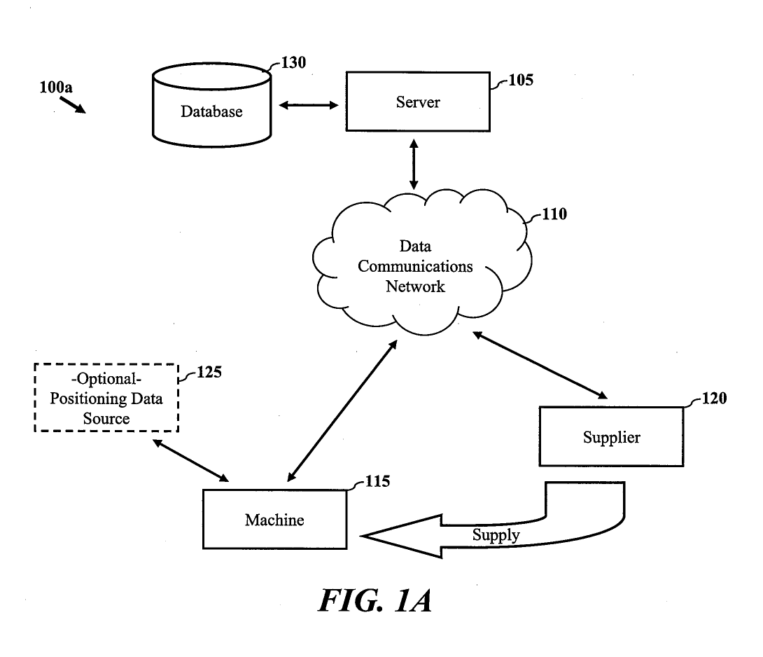

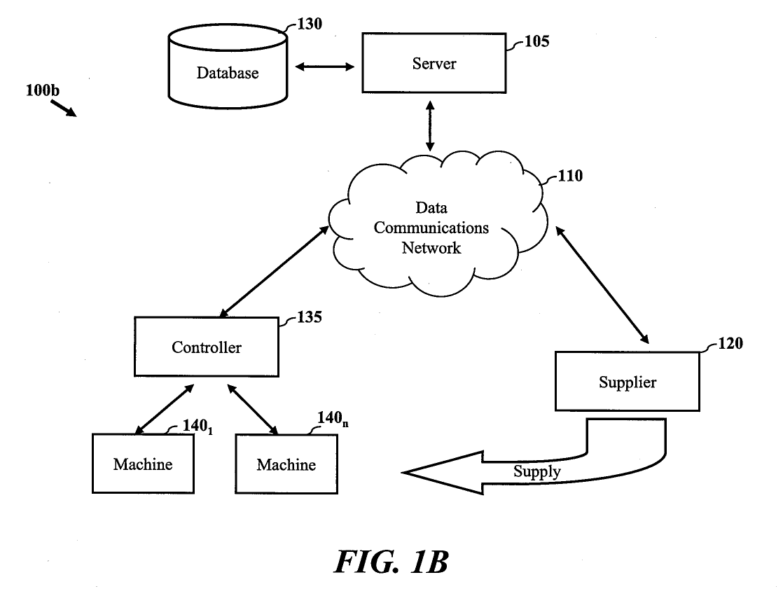

Referring now to the drawings, FIGS. 1A-1B illustrate simplified system diagrams according to one or more embodiments of the invention. Referring first to FIG. 1A, system 100a includes server 105 which may communicate with machine 115 to provide one or more consumables. According to another embodiment, machine 115 may communicate by using one or more communication protocols over data communications network 110 to provide data to, and receive data from, server 105. Additionally, machine 115 can interoperate with an optional positioning data source 125 to receive one or more signals which may be used to determine the spatial position of the machine. In certain embodiments, machine 115 may relate to a mobile machine. Fulfillment of a consumable may be based on a location of the machine. Server 105 may store location data for machine 115, such as one or more of a physical address, global navigation satellite system (GNSS) data, global positioning system (GPS) data and geo-spatial positioning data in general.

According to another embodiment, machine 115 may relate to a fixed machine. Fulfillment of a consumable may be based on a previously registered and/or recognizable location by one or more components of system 100a. By way of example, a purchaser or operator of the machine could register with server 105, such that machine 115 could be configured to notify a supplier of the machines location and need for a consumable.

System 100a may be configured to provide one or more consumables to machine 115 by one or more suppliers. As shown in FIG. 1, server 105 can communicate with supplier 120 for delivery of a consumable to machine 115. Server 105 may be configured to negotiate, place an order for, and coordinate fulfillment of an order for a consumable with supplier 120. While FIG. 1 illustrates a single supplier, supplier 120, it may be appreciated that server 105 may be configured to communicate with a plurality of suppliers using data communications network 110. Similarly, it may also be appreciated that server 105 may be configured to communicate with a plurality of machines using data communications network 110. In one embodiment, database 130 may be configured to store one or more preferences and attributes of machine 115 and supplier 120. According to another embodiment, database 130 may be configured to store one or more records related to one or more of requests for a required service, fulfilled services and pending services of consumables to machine 115. According to another embodiment, database 130 may be configured to store an identifier of machine 115 to provide one or more consumables. In one embodiment, the identifier of machine 115 may be captured at the time of sale. According to another embodiment, the identifier may be generated by registering machine 115 with server 105.

Referring to FIG. 1B, system 100b relates to another embodiment of the system of FIG. 1A. System 100b may be configured to provide consumables to one or more machines which may be coupled to an intermediary device. In one embodiment, server 105 may be configured to communicate with one or more of machines 140₁₋ₙ associated with controller 135. In an exemplary embodiment, machines 140₁₋ₙ may relate to a printer or peripheral device for controller 135. Further, machines 140₁₋ₙ may operate using a consumable substance. In one embodiment, machines 140₁₋ₙ can provide one or more signals to controller 135 when a consumable level is below a predefined threshold. Server 105 may be configured to negotiate delivery of a consumable to machines 140₁₋ₙ with supplier 120.

Machines 140₁₋ₙ may relate to stationary machines having a fixed location, according to one embodiment. As such, server 105 may be configured to sense and/or determine a physical address associated with machines 140₁₋ₙ. Alternatively, it may be appreciated that controller 135 may provide a physical address for machines 140₁₋ₙ. It may also be appreciated that controller 135 relates to a processing device which may be operated by a user. System 100b may be configured to provide fulfillment of a consumable to machines 140₁₋ₙ for continued operation.

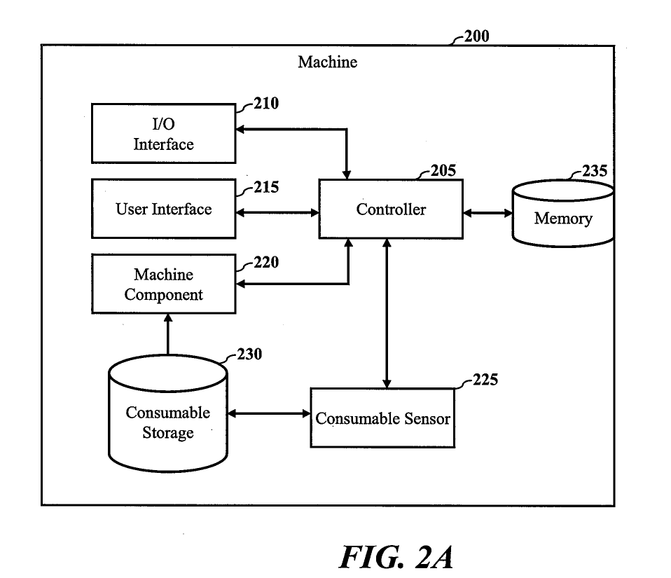

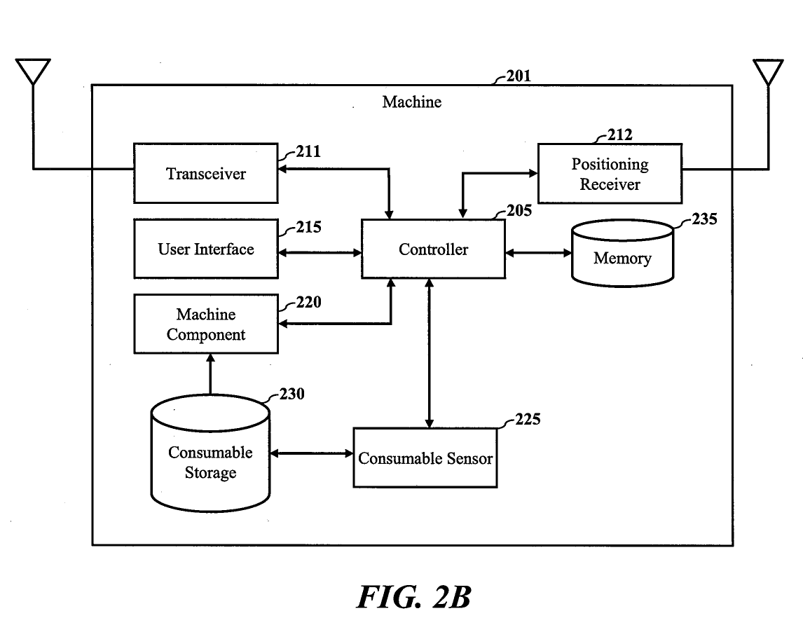

Referring now to FIGS. 2A-2B, simplified block diagrams are shown of machines which may be employed by the systems of FIGS. 1A-1B. Referring first to FIG. 2A, a simplified block diagram is shown for machine 200 (e.g., machine 115 or 140₁₋ₙ) according to one or more embodiments of the invention. Machine 200 may relate to a machine utilizing one or more consumable substances for operation. For example, machine 200 may relate to one or more of a vehicle, construction machine, vending machine, printing machine, duplication machine and a machine in general. As shown in FIG. 2A, machine 200 includes a controller 205 which can interoperate with input-output (I/O) interface 210, user interface 215, machine component 220 and consumable sensor 225. In one embodiment, machine 200 may employ I/O interface 210 for communication with a server (e.g., server 105) such that required service may be fulfilled for machine 200. I/O interface 210 may be configured to support wired and/or wireless communication with sensor 225. According to another embodiment, I/O interface 210 may be configured to receive data corresponding to a spatial location and/or orientation of machine 200. User interface 215 may be employed to provide, and receive, data from an operator, user and/or owner of machine 200. For example, a user may utilize user interface 215 to confirm delivery of a consumable.

It may also be appreciated that data received by controller 205 may be stored in memory 235. Memory 235 may be one of a ROM and RAM memory. According to another embodiment, controller 205 can be any type of processor such as a microprocessor, field programmable gate array (FPGA) and/or application specific integrated circuit (ASIC).

Consumable sensor 225 may be employed by machine 200 to detect the quantity of a consumable in consumable storage 230 employed by machine 200. In one embodiment, consumable sensor 225 may be configured to monitor quantity of consumables stored by consumable storage 230. Consumable sensor 225 may provide one or more signals providing the amount of a consumable to controller 205. In that fashion, an average use of a consumable by machine 200 may be determined. In one embodiment, consumable storage 230 may relate to one or more types of containers, cartridges and storage units. Further, consumable storage 230 may be based on a type of consumable and/or machine. In certain embodiments, machine 200 may include a plurality of consumable storage units associated with a plurality of consumables. Machine component 220 may relate to a component of the machine which requires a consumable for operation.

According to another embodiment, controller 205 may be configured to determine an estimated operational duration for machine 200 based on one or more of average use and the amount of consumable available. In one embodiment, controller 205 may be configured to output machine data including an amount and use of a consumable to a server (e.g., server 105) for fulfillment of a required service for machine 200. According to another embodiment, controller 205 may be configured to provide a notification when the quantity of a consumable has reached a predetermined threshold.

Referring now to FIG. 2B, a simplified block diagram is shown of another embodiment of machine 200 of FIG. 2A. As shown in FIG. 2B, machine 201 may relate to a machine utilizing one or more consumable substances for operation. In one embodiment, machine 201 may relate to one or more of a vehicle, a mobile device, construction machine, duplication machine, a vending machine and a machine in general. As shown in FIG. 2B, machine 201 includes a controller 205 which can interoperate with transceiver 211, positioning receiver 212, user interface 215, machine component 220 and consumable sensor 225. In one embodiment, machine 201 may employ transceiver 211 for communication with a server (e.g., server 105) for fulfillment of a required service for machine 200. Transceiver 211 may be configured for one or more of wired and wireless communication. According to another embodiment, machine 201 may include a positioning receiver 212 to receive data corresponding to a spatial location and/or orientation of machine 201. In one embodiment, controller 205 can receive at least one of global navigation satellite system (GNSS) data, global positioning system (GPS) data and geo-spatial positioning data in general via positioning receiver 212. According to another embodiment, positioning receiver 212 may receive ground based radio position data, 3D positioning system generated by a total station and/or any type of 3D positioning data in general.

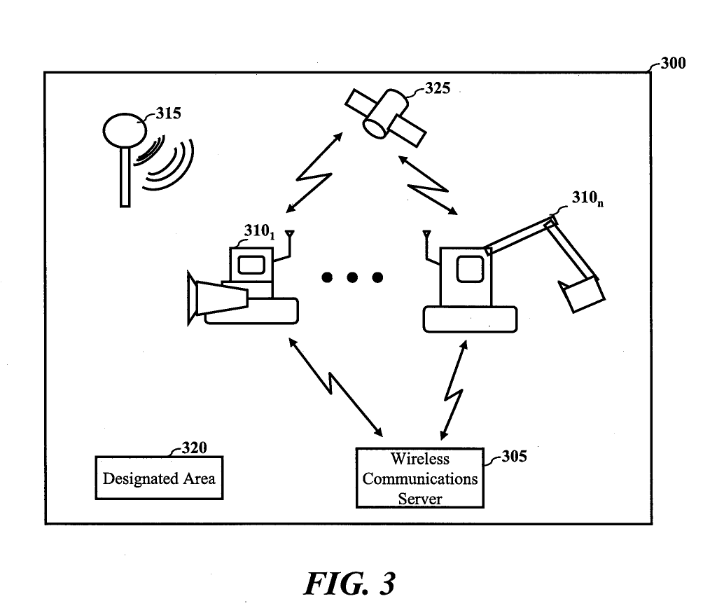

Referring now to FIG. 3, a graphical representation is shown of a work site according to one embodiment of the invention. As shown in FIG. 3, wireless communications server 305 (e.g., server 105) may provide a communication link for one or more machines 310₁₋ₙ (e.g., machine 115) in work site 300. Machines 310₁₋ₙ are depicted as earth moving machines according to one or more embodiments of the invention. However, it may be appreciated that machines 310₁₋ₙ may relate to other types of machines. In one embodiment, machines 310₁₋ₙ can communicate with server 305 to arrange fulfillment of one or more consumables.

According to one embodiment, machines 310₁₋ₙ can provide data to server 305 related to one or more of quantity of a consumable, usage of the consumable and/or position data. Machines 310₁₋ₙ may be configured to determine positioning data based on one or more signals received from a positioning data source 325 (e.g., positioning data source 125). Machines 310₁₋ₙ may be configured to receive spatial positioning and orientation data from positioning data source 325. Based on the data associated with a machine, server 305 may be configured to dispatch one or more consumables to the machine. In certain embodiments, server 305 can notify the machine of a particular time and location for delivery. Further, server 305 can specify delivery of a consumable to a particular location, such as desired location 320 illustrated in FIG. 3. In this fashion, delivery of the consumables may be provided to one or more machines for large worksites. According to another embodiment, server 305 may be configured to arrange delivery for one or more of machines 310₁₋ₙ. Further, work site 300 may include one or more wireless communications points 315, which may be employed to support communications for machines 310₁₋ₙ with a data communications network (e.g., data communications network 110). While machines 310₁₋ₙ are shown as earthmoving machines and the system is described as relating to a work site in FIG. 3, it should be appreciated that the system may be applied to other types of machines and operational environments. For example, the system may be employed to replenish agricultural spray equipment. The system of FIG. 3 may also service stationary equipment such as a printer or vending machine.

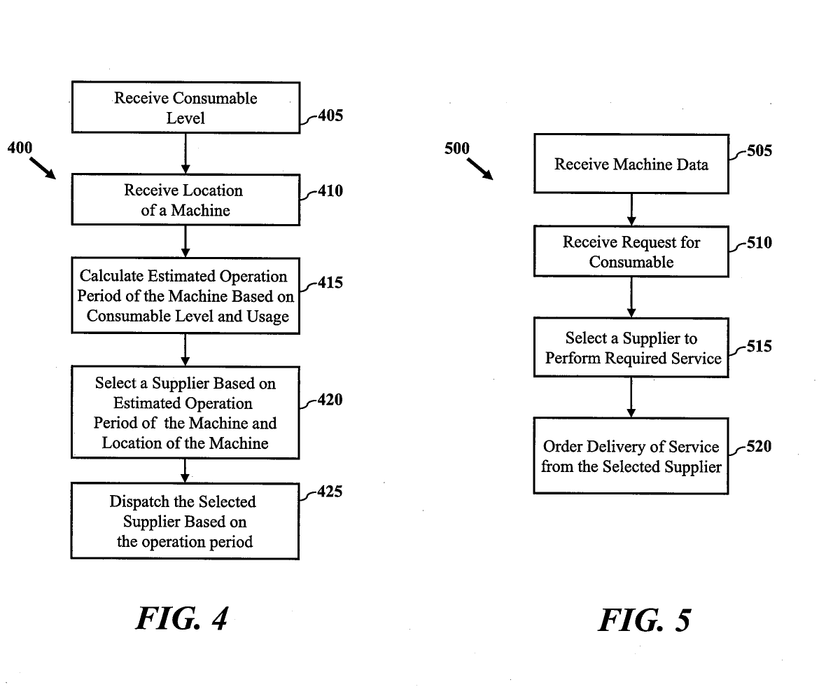

Referring now to FIG. 4, process 400 is shown for replenishing a consumable resource of a machine (e.g., machine 115) according to one or more embodiments of the invention. Process 400 may be initiated based on receiving a consumable quantity for a machine by a server (e.g., server 105) at block 405. The spatial position and/or location of the machine may be received at block 410. According to one embodiment, an estimated operation duration may be calculated for the machine based on the consumable level and usage rate of the machine at block 415. The server can select a supplier based on the estimated operational duration of the machine and/or location of the machine at block 420. According to another embodiment, selection of a supplier may be based on supplier location, shipping costs of a consumable, handling fees for a consumable and/or general fees which may be associated with the consumable. The server may dispatch a selected supplier based on the operation period at block 425.

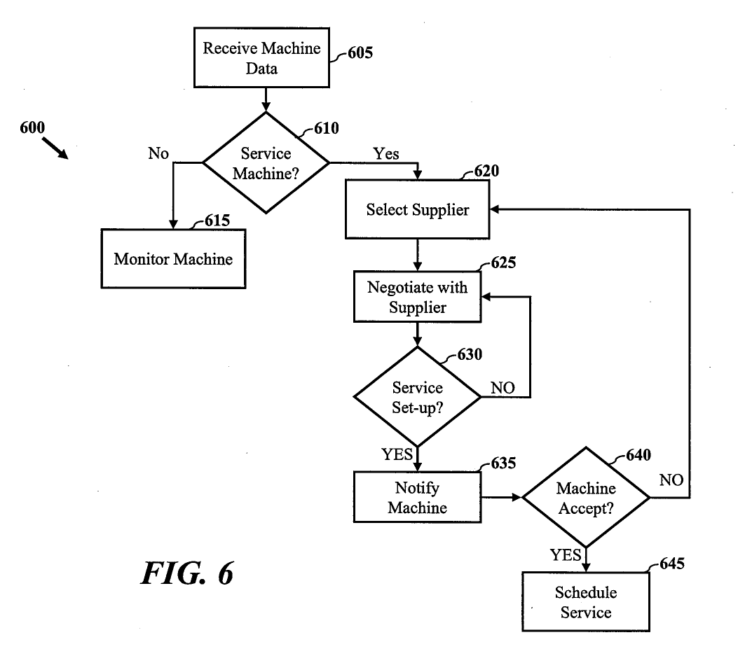

Referring now to FIG. 5, process 500 is shown for ordering delivery of service for a machine according to one or more embodiments of the invention. Process 500 may be initiated by a server (e.g., server 105) receiving machine data at block 505. Machine data may be received by the server when the machine is purchased or registered by an owner and/or operator. Machine data received at block 505 may include a location of the machine (e.g., machine 115), amount of a consumable available to a machine, operational longevity of the machine, supplier preference and the type of consumable. At block 510, the server receives a request from the machine for a consumable. The request may be generated by the machine based on one or more of a quantity of a consumable, a period of time and expected operational period of the machine. The server may select a supplier to perform a required service at block 515, as will be discussed in more detail with respect to FIG. 6 below. The server can order delivery of the required service from the selected supplier at block 520.

Referring now to FIG. 6, a process is shown for selecting a supplier according to one or more embodiments of the invention. Process 600 may be initiated by a server (e.g., server 105) receiving data for a machine (e.g., machine 115) at block 605. Based on received machine data, the server can determine if service is required for the machine at block 610. For example, in one embodiment a server may determine if the machine requires delivery of fuel. In another embodiment, machine data may include a request for delivery of a consumable. As such, the server may receive a request for fuel, oil, water, a machine part and/or consumable substance in general. When the server determines that service is not required for the machine (e.g., “No” path out of block 610), the server can monitor the machine at block 615 to monitor the level of one or more consumables for future service. However, when service is required for the machine (e.g., “Yes” path out of block 610), the server can select a supplier to provide service to the machine at block 620. Selecting a supplier at block 620 may be based on one or more of machine data received at block 605, a preferred supplier, a contract with a supplier, cost of required service and a server calculation. Selection of a supplier may also be based on an original supplier of the consumable to the machine, such as a machine manufacturer and/or distributor of the consumable.

Process 600 may further include negotiating with a selected supplier at block 625. In one embodiment, negotiations may be performed by the server to ensure fulfillment of a required service for a machine within a predetermined period of an estimated operational duration of the machine. The server may support electronic negotiations by an automated message and/or application system. According to another embodiment, negotiations may include electronic transmission of an available request to one or more suppliers. When a preferred supplier exists for the machine, negotiations may be sent only to the preferred supplier. The server can determine if negotiations have been established at block 630. It may also be appreciated that negations may be performed with a plurality of service providers. When the server determines that service is not established for the machine (e.g., “No” path out of block 630), the server may continue negotiations with a supplier at block 625. However, when the server determines that service is established for the machine (e.g., “Yes” path out of block 630), the server can notify the machine at block 635. Machine notification may be provided to an operator of the machine by a machine-user interface (e.g., user interface 215).

Continuing to refer to FIG. 6, process 600 may include determining if the machine accepts an established service request at block 640. In one embodiment, a machine affirmation may be in the form of an acceptance message. When the machine does not accept the service request (e.g., “No” path out of block 640), the server can select a supplier at block 620. The selected supplier may include a previously selected supplier for negotiations. When the machine accepts the service request (e.g., “Yes” path out of block 640), the server can schedule service for the machine at block 645. Scheduling service at block 645 may include payment and/or confirmation of a service request with a supplier. In another embodiment, scheduling service at block 645 may include setting a destination area, time and location (e.g., designated area 320).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for providing consumables to machines, the method comprising the acts of:
receiving machine data, by a server, indicating a remaining quantity of a machine consumable for a machine;
receiving location data, by the server, providing a location of the machine;
determining an estimated operational duration for the machine;
selecting a supplier to provide the machine consumable based, at least in part, on the estimated operational duration; and
requesting that the supplier provide the machine consumable to the machine within a time period based on the estimated operational duration.

2. The method of claim 1, wherein the machine consumable relates to at least one of ink, paper, fuel, propellant, usable substance and a consumable resource.

3. The method of claim 1, wherein the location data comprises at least one of a physical address, global navigation satellite system (GNSS) data, global positioning system (GPS) data and geo-spatial positioning data in general.

4. The method of claim 1, wherein the estimated operational duration relates to an estimated time the machine can operate based on at least one of the remaining quantity of the machine consumable and an operational history of usage for the machine.

5. The method of claim 1, wherein the estimated operational duration is received from the machine.

6. The method of claim 1, wherein selecting the supplier comprises negotiating fulfillment of the machine consumable to the machine based on at least one of cost for the required service, distance of the supplier, time that service may be completed, an original supplier of the machine and preferred supplier of the machine.

7. The method of claim 1, further comprising negotiating, by the server, delivery parameters of the machine consumable.

8. The method of claim 1, further comprising receiving updated machine data at predetermined time intervals and maintaining a record of one or more machine consumables provided to the machine.

9. The method of claim 1, further comprising receiving updated machine data when the machine determines there is a need for a consumable.

10. The method of claim 1, further comprising notifying a machine operator of at least one of a scheduled time, date and location of delivery of the machine consumable.

11. A system for automated delivery of machine services, the system comprising:
a machine configured to operate using a machine consumable;
a supplier configured to supply the machine consumable; and
a server configurable to communicate with the machine and supplier, the server configured to:
receive machine data indicating a remaining quantity of a machine consumable for a machine;
receive location data providing a location of the machine;
determine an estimated operational duration for the machine;
select a supplier to provide the machine consumable based, at least in part, on the estimated operational duration; and
request that the supplier provide the machine consumable to the machine within a time period based on the estimated operational duration.

12. The system of claim 14, wherein the machine consumable relates to at least one of ink, paper, fuel, propellant, usable substance and a consumable resource.

13. The system of claim 14, wherein the location data comprises at least one of a physical address, global navigation satellite system (GNSS) data, global positioning system (GPS) data and geo-spatial positioning data in general.

14. The system of claim 14, wherein the estimated operational duration relates to an estimated time the machine can operate based on at least one of the remaining quantity of the machine consumable and an operational history of usage for the machine.

15. The system of claim 14, wherein the estimated operational duration is received from the machine.

16. The system of claim 14, wherein selecting the supplier comprises negotiating fulfillment of the machine consumable to the machine based on at least one of cost for the required service, distance of the supplier, time that service may be completed, an original supplier of the machine and preferred supplier of the machine.

17. The system of claim 14, wherein the server is further configured to negotiate delivery parameters of the machine consumable.

18. The system of claim 14, wherein the server is further configured to receive updated machine data at predetermined time intervals and maintain a record of one or more machine consumables provided to the machine.

19. The system of claim 14, wherein the server is further configured to receive updated machine data when the machine determines there is a need for a consumable

20. The system of claim 14, wherein the server is further configured to notify a machine operator of at least one of a scheduled time, date and location of delivery of the machine consumable.
